(19) United States
(12) Patent Application Publication
(10) Pub. No.: US 2025/0093911 A1
(43) Pub. Date: Mar. 20, 2025

(54) ELECTRONIC DEVICE WITH BALLAST

(71) Applicant: Apple Inc., Cupertino, CA (US)

(72) Inventors: John S. Camp, Los Gatos, CA (US); Megan Grant, San Francisco, CA (US); Michael E. Savery, New York, NY (US); John A. Porcella, Campbell, CA (US)

(21) Appl. No.: 18/824,146

(22) Filed: Sep. 4, 2024

Related U.S. Application Data
(60) Provisional application No. 63/583,858, filed on Sep. 19, 2023.

(51) Int. Cl. G06F 1/16

(52) U.S. Cl. CPC G06F 1/163

(57) ABSTRACT

A wearable device includes a display including a display weight, a connecting band including a battery and a processor, a fulcrum strap positioned above the connecting band, a counterbalance strap positioned above the connecting band, and a weighted pad attached to the counterbalance strap. The weighted pad is at least partially counterbalancing a weight of the display about the fulcrum strap.

### CROSS-REFERENCE TO RELATED APPLICATION

This application claims the benefit of U.S. Provisional Patent Application No. 63/583,858 filed 19 Sep. 2023, and entitled “ELECTRONIC DEVICE WITH BALLAST,” the entire disclosure of which is hereby incorporated by reference.

### FIELD

The described embodiments relate generally to electronic devices. More particularly, the present embodiments relate to weight distribution across electronic devices.

### BACKGROUND

Recent advances in portable computing have enabled head-mountable devices that provide augmented reality and virtual reality (AR/VR) experiences to users. Such head-mountable devices can include various components such as a display, a viewing frame, lenses, a battery, motors, speakers, and other components. These components can operate together to provide an immersive user experience. In particular, head mountable-devices include components that help provide a distraction-free setting by blocking or sealing out the outer environment (e.g., ambient light).

However, head-mountable devices seek to facilitate prolonged and comfortable use, so that users can use the devices for all contemplated uses. Therefore, a head-mountable device that increases comfort and facilitates extended use is desired.

### SUMMARY

In one example, a wearable device includes a display, a connecting band including a processor, a fulcrum strap positioned above the connecting band, a counterbalance strap positioned below the connecting band, and a weighted pad attached to the counterbalance strap. The weighted pad is at least partially counterbalancing a weight of the display about the fulcrum strap.

In at least one example, the wearable device further includes a connection point rotatably coupling the connecting band, the fulcrum strap, and the counterbalance strap.

In at least one example, the connection band has a first moment arm and the counterbalance strap has a second moment arm.

In at least one example, an angle between the fulcrum strap and the counterbalance strap is adjustable.

In at least one example, a center of gravity for the wearable device is positioned below the connection point based on a height positioning of the weighted pad being lower than the connection point.

In at least one example, the counterbalance strap is rigid.

In at least one example, a length of the counterbalance strap is adjustable.

In at least one example, the weighted pad is centered along the counterbalance strap.

In at least one example, the weighted pad is removable from the counterbalance.

In one example, a head-mountable device includes a display, an occipital securement strap including a surface positionable toward a user head, a conformable ballast attached to the surface, and a band extending from the display to the occipital securement strap. The conformable ballast comprises a density greater than a density of the occipital securement strap and the band.

In at least one example, a ratio of a mass of the display and a mass of the conformable ballast is between 1/3 and 2/3.

In at least one example, the head-mountable device further includes a connection point between the occipital securement strap and the band.

In at least one example, the head-mountable device further includes a sagittal strap rotatably coupled to the occipital securement strap and the band at the connection point.

In at least one example, a center of gravity of the head-mountable device is located approximately at the connection point.

In one example, a ballast for wearable devices includes a housing detachable from a wearable device, a first compartment defined by the housing, a second compartment defined by the housing, a first lot of ballast material movably positioned in the first compartment, and a second lot of ballast material movably positioned in the second compartment.

In at least one example, the ballast further includes a separator isolating the first compartment and the second compartment.

In at least one example, a distance between the first compartment and the second compartment is adjustable.

In at least one example, the first lot of ballast material and the second lot of ballast material each include a granular material.

In at least one example, the granular material includes granules having a spherical shape.

In at least one example, the housing has a shaped configuration in which the first compartment and the second compartment are aligned in a row.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a side view of a head-mountable device being worn on a head of a user, according to one example;

FIG. 1B illustrates a side view of the head-mountable device with physical quantities, such as forces, moment arms, and relative angles schematically indicated, according to one example;

FIG. 2 illustrates a top view of a wearable device with a conformable ballast, according to one example;

FIG. 3 illustrates a top view of a wearable device with a ballast including a housing, a first compartment, and a second compartment, according to one example;

FIG. 4 illustrates a top view of a wearable device with a ballast including a housing, a first compartment, a second compartment, and a third compartment, according to one example;

FIG. 5A illustrates an interior portion of a compartment of a ballast, the compartment including spherical granules, according to one example;

FIG. 5B illustrates an interior portion of a compartment of a ballast, the compartment including amorphous granules, according to one example; and

FIG. 5C illustrates an interior portion of a compartment of a ballast, the compartment including uniform granules, according to one example.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a head-mountable device which can include a display portion including a display, a facial interface, a securement assembly to secure the head-mountable device to a user's head, and one or more sensors, processors, controllers, and the like.

When a conventional head-mountable device is worn by a user, a portion of the conventional head-mountable device can contact the user's face. The weight of the device and/or the mode of attaching the device to the user's head can apply pressure to the user's face and head.

In contrast to conventional devices, a head-mountable device of the present disclosure can include a counterweight to help improve user comfort. For example, the head-mountable device adds a counterweight to the securement assembly, which at least partially straps behind the user's head, opposite to the user's face, to help alleviate or counterbalance some of the pressure exerted on the user's face. In so doing, the counterweight can increase user comfort, especially when using the head-mountable device for prolonged durations of time. The counterweight can be included in various ways. In one example, the entire securement strap can be weighted. In other examples, weights, in the form of packets, pillows, attachments, etc., can be secured to the securement strap. In some examples, weights can be integrated onto, or secured on, the securement strap in a variety of configurations, such as in a form featuring one or more aligned or distributed compartments that allow the securement strap to be curved and conformed about the shape of the user's head.

The counterweight or weight can include various materials. Likewise, the counterweight can include various sizes, shapes, and form factors, such as tungsten spheres which allow the spheres to behave fluidly with respect to one another to provide conformance and comfort to the user.

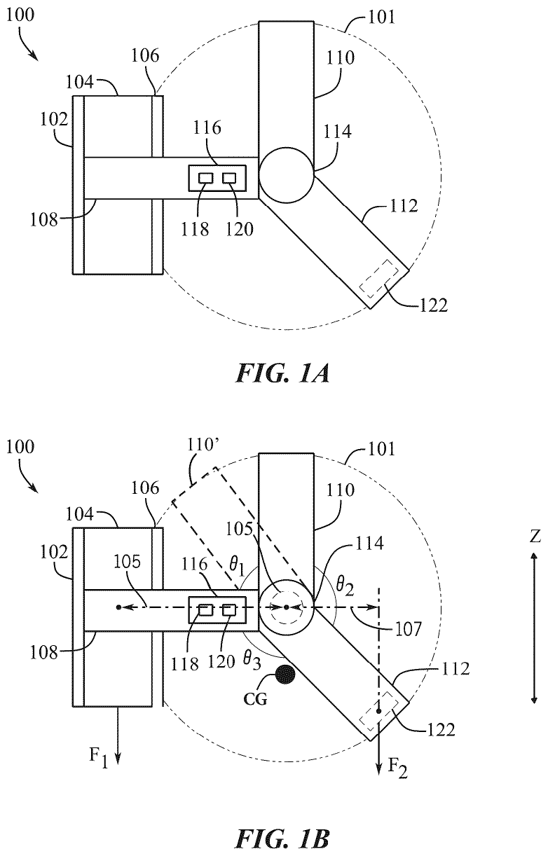

These and other examples are discussed below with reference to FIGS. 1-5. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a side view of a head-mountable device 100 being worn on a head 101 of a user, according to one example. The head-mountable device 100, as well as other wearable electronic devices disclosed herein, can also be referred to as head-mountable systems, electronic devices, wearable devices or apparatuses, or simply as devices. The head-mountable device 100 can include a number of components, including modular components, interchangeable components, etc. For example, the head-mountable device 100 can include a display 102, a housing 104, and a face engagement feature 106 attached to the housing 104.

The display 102 can also be referred to as a display portion or display module. The display 102 can include a display weight and can be mechanically and electrically coupled to the housing 104. In one or more examples, including the example shown in FIG. 1 and other examples shown in other figures, the display 102 can also be referred to as an output component or output module. Such output components, modules, or portions can include one or more outputs other than visual outputs from a display. For example, an output module similar to the display 102 can include a speaker that outputs sound instead of, or in addition to, the display 102. As another example, the display 102 (as an output module) can include a haptic interface for generating vibrations or other sensory outputs. As used herein, the display weight can refer to a force acting on the display 102 and the housing 104, the force being equal to a product of gravitational acceleration and the combined masses of the display 102 and the housing 104.

The head-mountable device 100 can also include the face engagement feature 106. As used herein, face engagement feature refers to a portion of the head-mountable device 100 that engages and/or seals a user face via direct contact. In particular, a face engagement feature can include portions of the head-mountable device 100 that conform to (e.g., compress against) regions of the user face and at least partially block ambient light from penetrating the space between the display 102 and the user's face. For example, a face engagement feature can include a pliant (or semi-pliant) face track or foam that spans the forehead, wraps around the eyes, contacts the zygoma and maxilla regions of the face, and bridges the nose. Furthermore, a face engagement feature can include various components forming a structure, webbing, cover, fabric, or frame of a head-mountable device disposed between the display 102 and the skin of a user. In particular implementations, a face engagement feature can include a seal (e.g., a facial interface, an environment seal, a dust seal, an air seal, etc.). It will be appreciated that the term “seal” can include partial seals or inhibitors, in addition to complete seals (e.g., a partial face engagement feature where some ambient light is blocked and a complete face engagement feature where all ambient light is blocked when the head-mountable device is donned).

Further, the head-mountable device 100 can include various connector(s). As used herein, the terms “connector” or “joint” refer to joints between the display 102, the housing 104, and/or the face engagement feature 106. In some examples, a connector allows the display 102 and/or the face engagement feature 106 to translate or rotate relative to the housing 104. In other examples, a connector can include a fixed or rigid bumper (e.g., a mechanical stop or structural post) positioned between the face engagement feature 106 and the housing 104. In at least some examples, the face engagement feature 106 can be removably attached to, and detached from, the housing 104 via one or more of the connectors. For instance, in certain examples, the face engagement feature 106 can be swapped out for a different face engagement feature. In other examples, the face engagement feature 106 is permanently attached to the connector(s). In particular implementations, the connector(s) can moveably constrain the face engagement feature 106 to the housing 104 at one or more various positions, such as a forehead region, a zygoma region, or a maxilla region.

As used herein, the term “forehead region” refers to an area of a human face between the eyes and the scalp of a human. Additionally, the term “maxilla region” refers to an area of a human face corresponding to the zygomatic bone structure of a human. Similarly, the term “maxilla region” refers to an area of a human face corresponding to the maxilla bone structure of a human. It will be appreciated that the foregoing regions can correspond to particular structure of the head-mountable device 100. However, such structure of the head-mountable device 100 is not dependent on a face or a user.

In addition, one example of the head-mountable device 100 can include a securement assembly that secures the head-mountable device 100 to the user's head 101. The securement assembly can include at least a connecting band 108, a fulcrum strap 110, and a counterbalance strap 112. The fulcrum strap 110 can be positioned above the connecting band 108 and at least partially along the top of the head 101. The counterbalance strap 112 can be positioned below the connecting band 108. As used herein, the terms “band” and “strap” can both be used to refer to a structure, material, and/or feature used to hold or mount the head-mountable device 100 to a user's head. In some examples a “strap” or “band” can be rigid, while in other examples, a “strap” or “band” can include flexures or joints, can be elastic, or can be flexible.

In some examples, the head-mountable device 100 can be worn on the user's head 101 such that the display is disposed over the one or both of the user's eyes. The connecting band 108 can run along sides of the user's head 101 toward the back of the head 101. The fulcrum strap 110 can wrap around a top (or fulcrum area) of the user's head 101, for example, to prevent the head-mountable device 100 to slide downward towards the user's chin and neck. The counterbalance strap 112 can run at least partially behind the user's head (e.g., opposite the face) to secure the head-mountable device 100 against the user's face.

In at least one example, a weighted pad 122 can be attached to the counterbalance strap 112. As used herein, the terms “weighted pad,” “ballast,” or “conformable ballast” refer to a cushion, pillow, pad, headrest, cradle, or support that can contact (e.g., comfortably contact or conform to) a user's head and that includes material to weight certain portions of the head-mountable device 100. For example, a weighted pad can be compressible, soft, moldable, pliant (or semi-pliant). In some examples, a weighted pad can also absorb applied forces or distribute pressure from wearing the head-mountable device 100. In some examples, the weighted pad 122 can at least partially counterbalance the display weight about the fulcrum strap 110. As described in reference to later figures, the weighted pad 122 can be removable from the counterbalance strap 112 or can be integrated with the counterbalance strap 112. In at least one example, the counterbalance strap 112 is rigid (e.g., within a plane parallel to the length of the counterbalance strap 112). Rigidity of the counterbalance strap can allow for the counterbalance strap 112 to be positioned at a desired position and angle by the user on the user's head 101. For example, a user with a “ponytail” might want the counterbalance strap 112 to be positioned below the ponytail. For another example, a user wearing a baseball cap backwards might want the counterbalance strap 112 to be positioned above the cap visor.

The head-mountable device 100 can further include a connection point 114 coupling the connecting band 108, the fulcrum strap 110, and the counterbalance strap 112. In at least one example, the connection point 114 can rotatably couple the connecting band 108, the fulcrum strap 110, and the counterbalance strap 112.

In at least one example, any or all of the connecting band 108, the fulcrum strap 110, or the counterbalance strap 112 can be removable. In particular, any of the connecting band 108, the fulcrum strap 110, or the counterbalance strap 112 can be removably connected to the housing 104 and/or the connection point 114 of the head-mountable device 100. As such, the securement assembly is modular in that any of the connecting band 108, the fulcrum strap 110, or the counterbalance strap 112 can be removed and interchanged for one or more different bands or straps.

In one example, the connecting band 108 can include an electronics pod 116. As used herein, the term “electronics pod” refers to a subassembly, an enclosure, or a shell dedicated for housing certain electronics. Some example electronics include a speaker, a memory device, a processor, a controller, a system on chip, a printed circuit board, etc. In particular implementations, electrical components of the electronics pod are communicatively coupled to the display 102 (e.g., via one or more cables or antennas). Additionally or alternatively, the electronics pod 116 can be coupled to one or more dongles, adapters, connectors, etc. In some examples, the electronics pod 116 can include electronics or ports for data and/or power transmission (e.g., via dongles or tethers). In some examples, the electronics pod 116 can couple to a power supply to charge and/or power one or more components within the electronics pod 116. For example, as depicted in FIG. 1, the connecting band 108 can include a battery 118 and a processor 120, which can be housed within the electronics pod 116.

FIG. 1B illustrates a side view of the head-mountable device 100 with physical quantities, such as forces, moment arms, and relative angles schematically indicated, according to one example. As illustrated, the connecting band 108 and the fulcrum strap 110 can form a mutual angle θ₁ at the connection point 114, with the connecting band 108 running along the sides of the head 101 and the fulcrum strap 110 running along a top of the head 101 and positioned above the connecting band 108. The fulcrum strap 110 and the counterbalance strap 112 can form a mutual angle θ₂ at the connection point 114. The counterbalance strap 112 and the connecting band 108 can form a mutual angle θ₃ at the connection point 114, with the counterbalance strap 112 positioned below the connecting band 108.

In some examples, one or more of the angle θ₁ between the connecting band 108 and the fulcrum strap 110, the angle θ₂ between the fulcrum strap 110 and the counterbalance strap 112, or the angle θ₃ between the counterbalance strap 112 and the connecting band 108 is adjustable. In some examples, the connection point 114 can be or can include a hinge 105, to allow for adjustment of the angles θ₁, θ₂, and/or θ₃.

Further, as indicated, the display weight exerts a downward force F₁ (resulting from the combined masses of at least the display 102, the housing 104, the face engagement feature 106, and in some cases, other components of the head-mountable device 100, such as electronics, connectors, user-added accessories, etc.) on the head-mountable device 100. As used in this context, “downward” refers to a direction parallel to the gravitational acceleration. In at least some examples, the connection band 108 includes a first moment arm 105 characterized by a perpendicular distance (e.g., the shortest distance) between a line along the force F₁ exerted by the display 102 and the axis of rotation (as depicted in FIG. 1B, the axis of rotation is located at the connection point 114). A first torque (calculated by obtaining the product of the magnitude of the force F₁ and the first moment arm) can be at least partially exerted on the facial area of the user's head 101. As used herein, a moment arm refers to a perpendicular distance between an axis of rotation (e.g., the connection point 114) and a force vector.

In at least one example, the counterbalance strap 112 and/or the weighted pad 122 exerts a downward force F₂ on the head-mountable device 100. In at least some examples, the counterbalance strap 112 includes a second moment arm 107 characterized by a perpendicular distance between a line along the force F₂ exerted by the weighted pad 122 and the axis of rotation (the connection point 114). A second torque (calculated by obtaining the product of the magnitude of the force F₂ and the second moment arm) in the opposite direction of the first torque can at least partially counter balance the first torque and alleviate the perceived pressure or force exerted on the user's face by the display 102 and the housing 104.

In at least one example, the counterbalance strap 112 is rigid (e.g., within a plane parallel to the length of the counterbalance strap 112). Rigidity of the counterbalance strap can allow the downward force F₂ to be exerted in a predictable manner (as compared to if the counterbalance strap were flexible, which could cause the force to be distributed in a less predictable manner). However, in some cases, the counterbalance strap 112 can be flexible.

In some examples, by adjusting one or more of the angle θ₁ between the connecting strap band and the fulcrum strap 110, the angle θ₂ between the fulcrum strap 110 and the counterbalance strap 112, or the angle θ₃ between the counterbalance strap 112 and the connecting band 108, the first torque and the second torque can be varied.

Therefore, the resultant force exerted on the user's face can be tuned. As will be described below, the force exerted on the user's face can additionally or alternatively be tuned by adjusting various factors, such as: (i) the weighted pad 122, (ii) the location of the weighted pad 122 along the counterbalance strap 112, (iii) the length of any of the connecting band 108, the fulcrum strap 110, or the counterbalance strap 112, (iv) the weight and weight distribution of any of the connecting band 108, the fulcrum strap 110, or the counterbalance strap 112, (v) etc. Any of the connecting band 108, the fulcrum strap 110, or the counterbalance strap 112 can include one or more clips, belts, straps, etc. to allow the user of the head-mountable device 100 to adjust the corresponding length of the band/strap about the user's head.

In at least one example, any of the various elements listed above can be adjusted to select a center of gravity of the head-mountable device 100 to maximize user comfort. In one example, the center of gravity can be located at the connection point 114. In other examples, the center of gravity can be positionally translated relative to the connection point 114 (e.g., forward, backward, upward, and/or downward relative to the connection point 114). In a specific example, and as shown in FIG. 1B, the center of gravity (referenced as “CG” in the figures) for the head-mountable device 100 can be located below the connection point 114. In at least one example, the fulcrum strap 110 has a weight (referred to as a fulcrum weight).

Positional tuning of the center of gravity CG can be achieved in various ways. In some examples, the weighted pad 122 can include a lowered height (e.g., in an up-down Z-direction along the height of the user) relative to at least one of the connecting band 108, the fulcrum strap 110, or the connection point 114. The lowered height positioning of the weighted pad 122, in turn, can lower the center of gravity CG for the head-mountable device 100. The mass of the weighted pad 122 can also be increased or decreased (e.g., depending on the relative Z-positioning) to achieve a desired location for the center of gravity CG of the head-mountable device 100.

Further, it will be appreciated that the weight of other elements of the head-mountable device 100 can be accounted for to achieve a desired location for the center of gravity CG of the head-mountable device 100. As an example, the weighted pad 122 can weigh more than a weight of the fulcrum strap 110, such that the center of gravity CG of the head-mountable device 100 is nevertheless lowered in the Z-direction relative to the connection point 114 (e.g., away from the top of the user's head 101). In some examples, lowering the center of gravity CG can stabilize the head-mountable device 100 on the user's head 101.

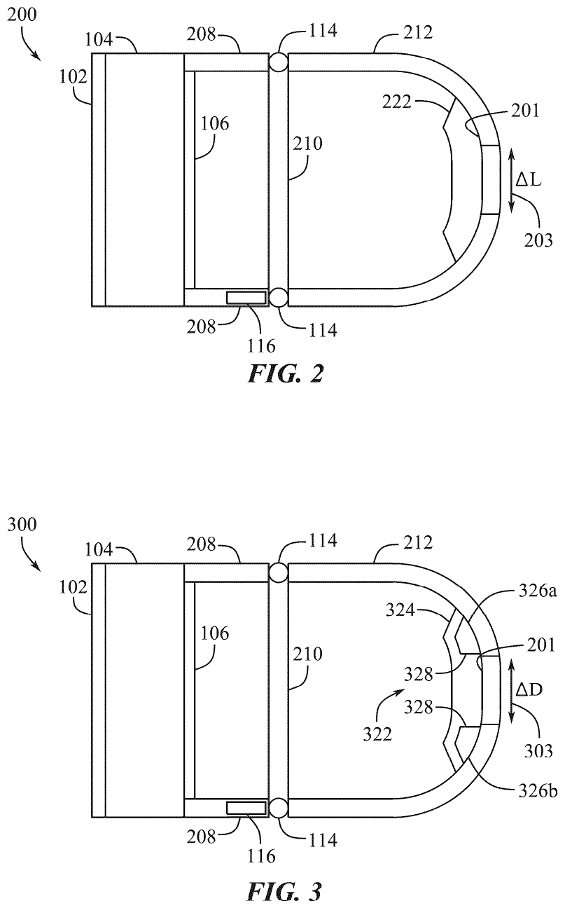

Any of the features, components, parts, including the arrangements and configurations thereof shown in FIGS. 1A-1B can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 1A-1B. Additional details of the counterbalance strap and the weighted pad are described in reference to FIG. 2.

FIG. 2 illustrates a top view of a wearable device 200 with a conformable ballast 222, according to one example. Although not all components are shown, the wearable device 200 is similar to the head-mountable device 100 of FIGS. 1A-1B, as noted by similar reference numbers.

The wearable device 200 includes the display 102, the housing 104, the face engagement feature 106, a band 208, the connection points 114, the electronics pod 116, and an occipital securement strap 212. The band 208 can be a connecting band, similar to the connecting band 208.

In at least one example, the occipital securement strap 212 can be the same as, or similar to, a counterbalance strap, such as the counterbalance strap 112 discussed above. The occipital securement strap 212 can include a surface 201 oriented or positional toward a user head (e.g., toward the display 102). The band 208 extends from the display 102 to the occipital securement strap 212.

In at least one example, the wearable device 200 further includes the connection point 114 between the occipital securement strap 212 and the band 208. The connection point 114 can mechanically couple the occipital securement strap 212 and the band 208. In one example, the connection point 114 can rotatably couple the occipital securement strap 212 and the band 208, such that a relative mutual angle (e.g., the angle θ₃ shown in FIG. 1) can be adjusted. In another example, the connection point 114 can statically couple the occipital securement strap 212 and the band 208, such that the relative mutual angle remains fixed.

In at least one example, the wearable device 200 further includes a sagittal strap 212. The sagittal strap 212 can be the same as or similar to the fulcrum strap 110 discussed above. The sagittal strap 212 can be mechanically coupled or directly connected to the occipital securement strap 212 and the band 208 at the connection point 114. In one example, the sagittal strap 210 can be rotatably coupled to the occipital securement strap 212 and the band 208, such that at least some of the relative mutual angles (e.g., the angles θ₁, θ₂, or θ₃) can be adjusted, or adjusted and then fixed. In another example, the connection point 114 can statically couple the occipital securement strap 212 the band 208, sagittal strap 210, such that the relative mutual angle remains fixed.

The wearable device 200 further includes a conformable ballast 222 attached to the surface 201. For example, the conformable ballast 222 can be in contact with the back of the user's head while the wearable device 200 is being worn by the user. The conformable ballast 222 can be a weighted pad, such as the weighted pad 122. In at least one example, the conformable ballast 222 is centered on the occipital securement strap 212. In other words, the weighted pad can be centered on the counterbalance strap.

In at least one example, a length of the occipital securement strap 212 is adjustable. For example, a portion 203 of the occipital securement strap 212 can be length adjustable via elastic bands, buckles, straps, snap clips, etc., in such a way that the conformable ballast 222 remains centered along a length of the occipital securement strap 112 (e.g., to maintain symmetry between left and right halves of the wearable device 200).

The conformable ballast 222 can have a density that is greater than a density of at least the occipital securement strap 212 and the band 208. Furthermore, ratio of a mass of the display 102 and a mass of the conformable ballast 222 can be, according to some examples, between approximately 1/3 and 2/3, between approximately 1/4 and 3/4, between approximately 1/8 and 7/8, or between approximately 1/10 and 9/10.

The densities of the conformable ballast 222, the occipital securement strap 212, and the band 208, as well as the masses of the display 102 and the mass of the conformal ballast 222 can determine a center of gravity of the wearable device 200. As used herein, the center of gravity refers to a point about which the net torque due to gravitational forces is substantially eliminated. For example, a center gravity of the wearable device 200 can include a balance point about which the total torque due to gravitational forces is zero.

In at least one example, the center of gravity of the wearable device 200 is located approximately at the connection point 114. In other examples, the center of gravity of the wearable device can be shifted from the connection point 114 along the sagittal strap 210 away from the connection point. In other examples, the center of gravity can be shifted along the occipital securement strap 212 away from the connection point 114. In other examples, the center of gravity can be shifted along the band 208 away from the connection point 114 via a distribution and allocation of the masses in the system. In additional or alternative examples, the center of gravity can be shifted along one or more of the occipital securement strap 212, the band 208, or the sagittal strap 210 away from the connection point 114, at least in part by positioning of the conformable ballast 222.

In some examples, the user can manually determine the location of the center of gravity or otherwise manipulate the wearable device 200 to shift the center of gravity. For instance, the user can adjust one or more of the lengths of the band 208, the sagittal strap 210, or the occipital securement strap 212 to adjust respective moment arms. For example, the user can adjust the length 201 of the occipital securement band. The user can also adjust the weight of the conformable ballast 222, for example, by switching the conformable ballast 222 with a different conformable ballast having a differing weight.

In some examples, the location of the center of gravity can be automatically determined by the wearable device 200. One or more sensors can measure pressure exerted by the face onto either the display 102 or the housing 104, and determine that the pressure exceeds a predetermined threshold value. A controller of the wearable device 200 can cause one or more of the lengths of the band 208, the sagittal strap 210, or the occipital securement strap 212 to be adjusted until the pressure decreases below the threshold value. Additionally or alternatively, the controller can cause the weight of the conformable ballast 222 to be redistributed along the occipital securement strap 212.

Any of the features, components, parts, including the arrangements and configurations thereof shown in FIG. 2 can be included, cither alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 2. Additional details of a ballast for counterbalancing the wearable device are described in reference to FIG. 3.

FIG. 3 illustrates a top view of a wearable device 300 with a ballast 322 including a housing 324, a first compartment 326a, and a second compartment 326b, according to one example. Although not all components are shown, the wearable device 300 is similar to the head-mountable device 200, as noted by similar reference numbers.

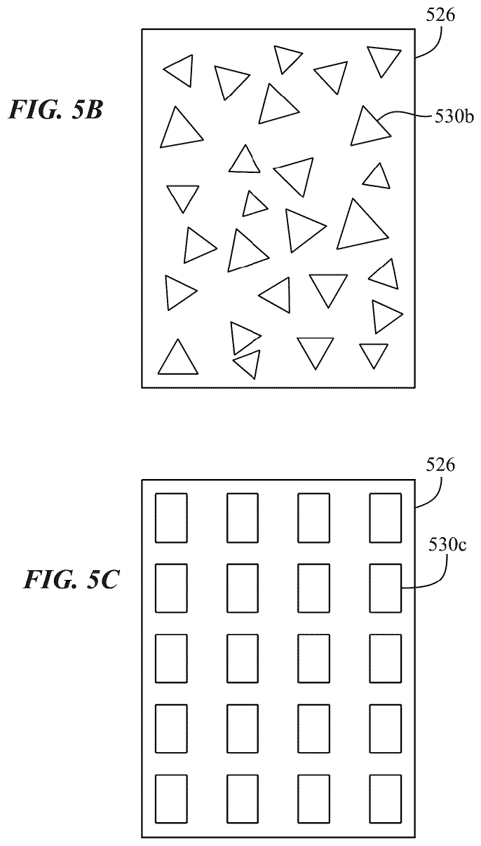

In at least one example, the ballast 322 includes a housing 324, a first compartment 326a, a second compartment 326b. The housing 324 can be detachable from the wearable device 300. The first compartment 326a and the second compartment 326b can each be defined by the housing. A first lot of ballast material (exemplarily shown in FIGS. 5A-5B) can be movably positioned in the first compartment 326a. A second lot of ballast material (exemplarily shown in FIGS. 5A-5B) can be movably positioned in the second compartment 326b.

The first lot of ballast material and the second lot of ballast material each include a granular material. The granular material can make up at least a portion of the first lot of ballast material or the second lot of ballast material, respectively. As discussed with reference to FIGS. 5A-5B, the lots of ballast material can include various materials of various shapes, which can determine properties of the ballast 322, including the first compartment 326a and the second compartment 326b.

In at least one example, the ballast 322 includes a separator 328 isolating the first compartment 326a and the second compartment 326b. In some examples, the separator 328 can include one or more walls or coverings of the first compartment 326a or the second compartment 326b. In other examples, the separator 328 can include a separate barrier separating the first compartment 326a from the second compartment 326b. In one example, the separator 328 can fully isolate the first compartment 326a from the second compartment 326b. In this way, the first lot of ballast material and the second lot of ballast material are prohibited from being mixed. In other examples, the separator 328 can partially separate the first compartment 326a from the second compartment 326b, such that at least a portion of the first lot of ballast material and/or a portion of the second lot of ballast material can flow or otherwise be exchanged between the first compartment 326a and the second compartment 326b. A partial separator can control the rate and/or volume of flow of ballast material between the first compartment 326a and the second compartment 326b.

In at least one example, a distance ΔD 303 between the first compartment 326a and the second compartment 326b is adjustable. In one example, the distance 303 can be adjustable by adjusting the length (e.g., the length 203 shown in FIG. 2) of the occipital securement strap 212. In an additional or alternative example, the first compartment 326a and the second compartment 326b can be movable along the occipital securement strap 212, and can be translated along the occipital strap 212 to adjust the distance 303 between the first compartment 326a and the second compartment 326b. For instance, for users with smaller heads, the first compartment 326a and the second compartment 326b can be positioned closer together (e.g., to appropriately adjust the moment arm for smaller heads). In contrast, for users with larger heads, the first compartment 326a and the second compartment 326b can be positioned farther apart. Accordingly, the adjustability of the ballast 322 can help reduce the perceived variance of pressure and resultant forces between larger and smaller head sizes.

In at least one example, the ballast 322 is a removable weight. Specifically, in some examples, the ballast 322 can be removed from the occipital securement strap 212 (e.g., the counterbalance strap). In addition to (or alternatively to) being movable, either one or both of the first compartment 326a or the second compartment 326b can be removable from the occipital securement strap 212. In one example, the occipital securement strap 212 can include a fastening mechanism which allows the occipital securement strap 212 to be separated. A fastening mechanism can include a buckle, magnet, hook on loop, button, snap, press-fit attachment, friction fit attachment, mating feature, interlocking feature, tape, glue, weld, etc. Such a configuration can allow at least a portion of the ballast 322 to detach from (e.g., slide off of, snap off of, etc.) the occipital securement strap 212. In additional or alternate examples, the ballast 322 can include buckles, pins, magnets, etc. for removable coupling to the occipital securement strap.

In at least one example, the ballast 322 can have a shaped configuration. The shaped configuration can include a configuration corresponding to a polygonal shape (e.g., a square, rectangle, oval, etc.). In other examples, the shaped configuration can include an arrangement of multiple ballasts or compartments of ballast material. The arrangement of ballast compartments can take on various form factors, sizes, and shapes. In some examples, the arrangement of ballast compartments includes a configuration with multiple ballast compartments arranged (e.g., aligned in a horizontal row) along the interior surface of the occipital securement strap 212 separated by a flexible material. In this case, the first compartment 326a and the second compartment 326b can form a two-compartment configuration of adjacent ballasts. In particular, the first compartment 326a and the second compartment 326b can be disposed on the surface 201 of the occipital securement strap 212. The repeating ballast compartment configuration can allow the occipital securement strap 212 to conform to the shape of the back of the head of the user, while allowing the weighted pad of the ballast 322 to be evenly distributed and self-centering along the occipital securement strap 212.

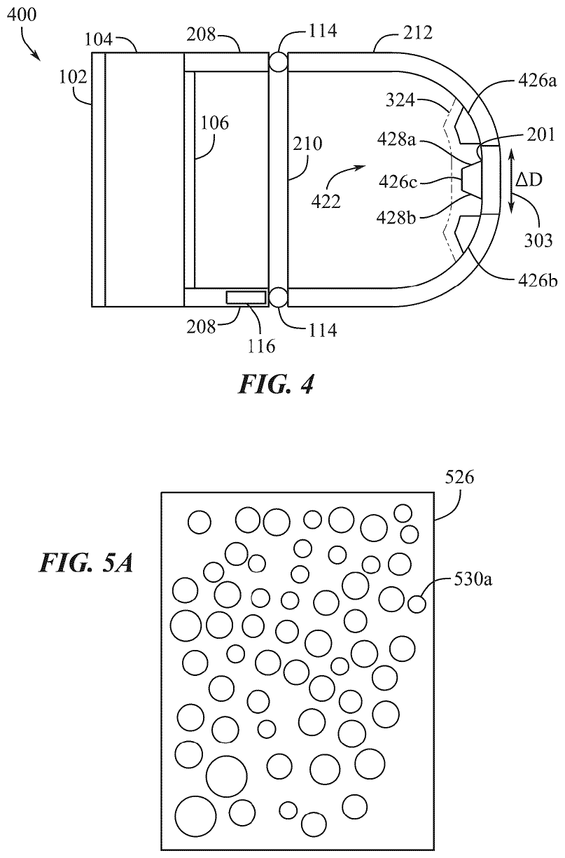

Any of the features, components, parts, including the arrangements and configurations thereof shown in FIG. 3 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 3. Additional details of additional ballast configurations are described in reference to FIG. 4.

FIG. 4 illustrates a top view of a wearable device 400 with a ballast 422 including a housing 424, a first compartment 426a, a second compartment 426b, and a third compartment 426c, according to one example. Although not all components are shown, the wearable device 400 is similar to the head-mountable device 300, as noted by similar reference numbers.

In at least one example, the housing 424 can include a shaped configuration in which the first compartment 426a and the second compartment 426b are aligned in a row. In one example, the ballast 422 can have a “gun belt” configuration, in which compartments 426a-426c line the surface 201 of the occipital securement strap 212. Any of the first compartment 426a, the second compartment 426b, or the third compartment 426c can be similar to the first compartment 326a or the second compartment 326b of FIG. 3.

In one example, the inclusion of multiple compartments to form the repeating and conformable ballast compartment configuration can increase uniformity of the distribution of weight along the occipital securement strap 212. In one example, the inclusion of multiple compartments to form the repeating and conformable ballast compartment configuration can increase rigidity of the occipital securement strap 212 within a plane parallel to the length of the occipital securement strap 212. In one example, the inclusion of multiple compartments to form the repeating and conformable ballast compartment configuration can allow for fine adjustment of the weighted pad by allowing for addition or removal of compartments 426.

Any of the features, components, parts, including the arrangements and configurations thereof shown in FIG. 4 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 4. Additional details granular materials are described in reference to FIGS. 5A-5C.

FIG. 5A illustrates an interior portion of a compartment 526 of a ballast, the compartment 526 including spherical granules 530a, according to one example. The compartment 526 can be substantially similar to the compartment 326 of FIG. 3 or the compartment 426 of FIG. 4.

In one example, the compartment 526 includes the granular material with granules having a spherical shapes. In at least one example, the granules 530a are tungsten, which can fluidly flow such that the compartment 526 conforms to a given shape, such as a section of the back of the user's head. In other examples, the granules 530a can include other types of high-density materials, such as brass, silicone, bismuth, etc.

In some examples, fluid motion of the granules 530a within the compartment 526 (as well as between various compartments, in the case of a partial separation between adjacent compartments) can allow the head-mountable device to self-center on the user's head by uniformly distributing the weight within the ballast.

FIG. 5B illustrates an interior portion of a compartment 526 of a ballast, the compartment 526 including amorphous granules 530b, according to one example. The compartment 526 can be substantially similar to the compartment 326 of FIG. 3 or the compartment 426 of FIG. 4.

In at least one example, the compartment 526 includes granular material wherein each granule 530b has a different or substantially different shape than each other granule. In one example, amorphous granular materials can at least partially prevent individual granules from flowing/sliding within the compartment 526. In one example, amorphous granular materials can provide the ballast with a rigid (e.g., more rigid compared to the spherical granular 530a) structure. Amorphous granular material can include water or more of sand, gel, brass, silicone, lead, bismuth, salt granules, etc.

In some examples, the relative lack of motion of the granules 530b within and between compartments can call for asymmetric loading of ballast compartments 526, for example, to account for asymmetries associated with the external environment (user's head, accessories added to straps/bands, etc.). To illustrate, the ballast compartments 526 can be preloaded (e.g., biased upward) in an asymmetrical fashion such that the ballast material appears asymmetrical pre-donning of the wearable device and symmetrical when the wearable device is donned by a user. In these or other examples, preloading the ballast compartments in this way can reduce or mitigate an asymmetrical appearance (e.g., a sagging appearance) of the ballast compartments after donning the wearable device.

FIG. 5C illustrates an interior portion of a compartment 526 of a ballast, the compartment 526 including uniform granules 530c, according to one example. The compartment 526 can be substantially similar to the compartment 326 of FIG. 3 or the compartment 426 of FIG. 4.

In at least one example, the compartment 526 includes granular material wherein each granule 530c has the same shape and size and every other granule 530c. In one example, uniform granules can stack in a (tightly) packed structure, for example in a closest packed structure. In one example, uniform granules 530c can at least partially prevent individual granules from flowing/sliding within the compartment 526. In one example, uniform granules 530c can provide the ballast with a rigid (e.g., more rigid compared to the spherical granular material or the amorphous granular material) structure. Uniform granular material can include one or more of spherical beads (such as tungsten, silicone, etc.), certain forms of sand, salt, etc. Uniform granules 530c can have spherical shapes, rectangular cubic shapes, triangular pyramid shapes, hexagonal shapes, etc.

Numerous properties of the compartment(s) of the ballast can be varied. Some examples include: i) each compartment can have the same mass or density as the other compartments, or some compartments can have differing masses or densities; ii) the volume of each compartment can be the same or can be different; iii) granular materials within each compartment can be the same or can be different; iv) the separation between adjacent compartments can be the same, or some can be partial while others are total; v) spacing between adjacent compartments can be the same or can vary.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A wearable device, comprising:
a display;
a connecting band comprising a processor;
a fulcrum strap positioned above the connecting band;
a counterbalance strap positioned below the connecting band; and
a weighted pad attached to the counterbalance strap, the weighted pad being positionally adjustable to at least partially counterbalance a weight of the display about the fulcrum strap.

2. The wearable device of claim 1, further comprising a connection point rotatably coupling the connecting band, the fulcrum strap, and the counterbalance strap.

3. The wearable device of claim 2, wherein:
the weighted pad is positioned in a Z-direction lower than the connection point; and
a center of gravity for the wearable device is positioned below the connection point.

4. The wearable device of claim 1, wherein the connection band comprises a first moment arm and the counterbalance strap comprises a second moment arm.

5. The wearable device of claim 1, wherein an angle between the fulcrum strap and the counterbalance strap is adjustable.

6. The wearable device of claim 1, wherein the counterbalance strap is rigid.

7. The wearable device of claim 1, wherein a length of the counterbalance strap is adjustable.

8. The wearable device of claim 1, wherein the weighted pad is centered along the counterbalance strap.

9. The wearable device of claim 1, wherein the weighted pad is removable from the counterbalance strap.

10. A head-mountable device, comprising:
a display;
an occipital securement strap including a surface positionable toward a user head;
a conformable ballast attached to the surface; and
a band extending from the display to the occipital securement strap,
wherein the conformable ballast comprises a density greater than a density of the occipital securement strap and the band.

11. The head-mountable device of claim 10, wherein a ratio of a mass of the display and a mass of the conformable ballast is between 1/3 and 2/3.

12. The head-mountable device of claim 10, further comprising a connection point between the occipital securement strap and the band.

13. The head-mountable device of claim 12, further comprising a sagittal strap rotatably coupled to the occipital securement strap and the band at the connection point.

14. The head-mountable device of claim 12, wherein a center of gravity of the head-mountable device is located approximately at the connection point.

15. A ballast for wearable devices, the ballast comprising:
a housing detachable from a wearable device;
a first compartment defined by the housing;
a second compartment defined by the housing;
a first lot of ballast material movably positioned in the first compartment; and
a second lot of ballast material movably positioned in the second compartment.

16. The ballast of claim 15, further comprising a separator isolating the first compartment and the second compartment.

17. The ballast of claim 15, wherein a distance between the first compartment and the second compartment is adjustable.

18. The ballast of claim 15, wherein the first lot of ballast material and the second lot of ballast material each comprise a granular material.

19. The ballast of claim 18 wherein the granular material comprises granules having a spherical shape.

20. The ballast of claim 18, wherein the housing comprises a shaped configuration in which the first compartment and the second compartment are aligned in a row.
